(19) United States
(12) Patent Application Publication
(10) Pub. No.: US 2009/0123841 A1
(43) Pub. Date: May 14, 2009

(54) SECONDARY BATTERY ELECTRODE INK, LITHIUM-ION BATTERY, AND ELECTRONIC DEVICE

(75) Inventors: Toshimitsu HIRAI, Yamanashi (JP); Hiroshi TAKIGUCHI, Suwa (JP); Yasushi TAKANO, Matsumoto (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Tokyo (JP)

(21) Appl. No.: 12/264,547

(22) Filed: Nov. 4, 2008

(30) Foreign Application Priority Data
Nov. 14, 2007 (JP) 2007-295190

(51) Int. Cl. H01M 4/52; H01M 4/50; B05D 5/12

(52) U.S. Cl. 429/221; 429/223; 429/224; 429/231.4; 429/231.5; 429/231.95; 427/77

(57) ABSTRACT

A secondary battery electrode ink is adapted to be discharged from a droplet discharge device to make an electrode layer of a secondary battery. The secondary battery electrode ink includes an active substance including at least one of a positive electrode active substance and a negative electrode active substance, and a liquid medium. The liquid medium dissolves and/or disperses the active substance. The liquid medium has a characteristic in which, when a cured epoxy adhesive material is put into the liquid medium under a sealed condition at an atmospheric pressure and a temperature of approximately 50° C. and left for ten days, a weight increase rate of the cured epoxy adhesive material is 130% or less.

### CROSS-REFERENCE TO RELATED APPLICATIONS

This application claims priority to Japanese Patent Application No. 2007-295190 filed on Nov. 14, 2007. The entire disclosure of Japanese Patent Application No. 2007-295190 is hereby incorporated herein by reference.

### BACKGROUND

1. Technical Field

The present invention relates to a secondary battery electrode ink, a lithium-ion battery, and an electronic device.

2. Related Art

In the past, chiefly lead batteries were used as secondary batteries, i.e., batteries that can be discharged and recharged repeatedly. Later, nickel cadmium batteries and nickel chloride batteries were introduced and have come to be used in various applications. However, nickel cadmium batteries and nickel chloride batteries suffer from the practical problem of a memory effect and, consequently, lithium-ion batteries are becoming mainstream in recent years because they do not have a memory effect problem.

A lithium-ion battery has a three-layered structure comprising a sheet-like positive electrode material (positive electrode), a sheet-like negative electrode material (negative electrode), and a porous separator provided between the positive electrode material and the negative electrode material. The three-layered structure is immersed in an electrolytic solution and sealed in a metal can-like case. Each of the positive electrode material and the negative electrode material is an electrode having a current collector layer and an electrode layer containing an active substance provided on the collector layer.

Conventionally, when forming such a positive electrode material or negative electrode material, an electrode layer forming material containing an active substance is dissolved or dispersed in a liquid medium so as to make a slurry. The slurry is then applied to the current collector layer with a roll coater. Afterwards, the applied slurry is dried to remove the liquid medium and cured to form the electrode layer, thereby completing the positive electrode material (positive electrode) or negative electrode material (negative electrode).

However, with this kind of electrode forming method, the thickness of the coating applied with the roll coater cannot be made sufficiently thin and, consequently, the internal resistance of the resulting electrode layer cannot be made sufficiently low. Because of this problem, Japanese Laid-Open Patent Publication Nos. 2005-11656, 2005-11657 and 2006-172821 propose to replace the roll coating method with an inkjet method (droplet discharge method) in order to form the electrode layer.

By using an inkjet method (droplet discharge method) to form the electrode layer, the thickness of the applied coating can be made thinner such that the thickness of the resulting electrode layer is thinner and the internal resistance can be made sufficiently low. Additionally, patterning of the electrode layer can be accomplished more easily such that the discharge and recharge characteristics can be controlled.

### SUMMARY

As is described in Japanese Laid-Open Patent Publication Nos. 2005-11656 and 2006-172821, when an electrode layer is formed using an inkjet method, a resin portion of a droplet discharge head used to discharge the ink dissolves in the solvent (liquid medium) of the actual ink composition that is used. More specifically, the NMP or acetonitrile used as the solvent has a very strong polarity and is therefore extremely well-suited for dispersing the component materials used to make the electrode layer, e.g., metal oxides, conductive agents, dispersed resins, binders, and initiators. On the other hand, the same solvents cause tremendous damage to the resin portions used as an adhesive to join the members of the droplet discharge head. The adhesive layer sometimes dissolves out of the joined portions where solvent damage has occurred, thus causing the adhesive function to decline and making it impossible to ensure the mechanical strength and precision of the head that was guaranteed at the time of manufacture. As a result, the speed and positioning of the ink droplets discharged from the inkjet head become erratic and it becomes impossible to arrange the ink droplets in the targeted position. Furthermore, if the ink is allowed to remain inside the head for a long period of time without being discharged, then the polar components contained in the resin of resin members inside the head will dissolve out and contaminate the ink when discharging is resumed, thus causing impurities to be intermixed in the electrodes formed and causing the products made to incur quality variations.

The above mentioned prior art references do not make any concrete proposals for an ink composition configured to improve this problem. In order to form electrode layers using an inkjet method (droplet discharge method), it is imperative to consider the composition of the ink that is used. It particular, it is extremely important to select the solvent (liquid medium) properly.

The present invention was conceived in view of the situation described above and its object is to provide a secondary battery electrode ink that can reduce damage to a droplet discharge head used in a droplet discharge method, e.g., an inkjet method—particularly damage to an epoxy adhesive (resin portions) used in joints of such a droplet discharge head, thereby enabling a superior droplet discharge stability and a longer service life of the droplet discharge head. It is also an object of the present invention to provide a lithium-ion battery and an electronic device that are obtained using the secondary battery electrode ink.

A secondary battery electrode ink is adapted to be discharged from a droplet discharge device to make an electrode layer of a secondary battery. The secondary battery electrode ink includes an active substance including at least one of a positive electrode active substance and a negative electrode active substance. The positive electrode active substance includes one of or a mixture of a plurality of Li—Mn based metal oxide, Li—Ni based metal oxide, Li—Co based metal oxide and Li—Fe based metal oxide. The negative electrode active substance includes one of or a mixture of a plurality of graphite, graphitizable carbon, non-graphitizable carbon, Li—Ti based metal oxide, Li—Sn based metal oxide and Li—Si based metal oxide. The liquid medium dissolves and/or disperses the active substance. The liquid medium has a characteristic in which, when a cured epoxy adhesive material is put into the liquid medium under a sealed condition at an atmospheric pressure and a temperature of approximately 50° C. and left for ten days, a weight increase rate of the cured epoxy adhesive material is 130% or less.

When an electrode layer is made with this secondary battery electrode ink, the damage imparted to an epoxy adhesive by the liquid medium is small and, thus, the discharge stability of a droplet discharge head using an epoxy adhesive is excellent. Additionally, the service life of the droplet discharge head can be prevented from being shortened due to severe damage to the droplet discharge head.

In the secondary battery electrode ink as described above, the epoxy adhesive material preferably contains an epoxy resin and an aliphatic polyamine.

With such an epoxy adhesive, the nozzle plate of the droplet discharge head can be securely fixed to the head body. Additionally, the droplet discharge head can be effectively prevented from undergoing undesirable vibrations when liquid droplets are discharged from the droplet discharge head.

In the secondary battery electrode ink as described above, the liquid medium preferably has a boiling point of from 180° C. to 300° C. under an atmospheric pressure.

With such a liquid medium, clogging of the droplet discharge head with the secondary battery electrode ink can be prevented effectively and the productivity with which secondary battery electrodes are fabricated can be improved.

In the secondary battery electrode ink as described above, the liquid medium preferably has a vapor pressure of 0.1 mm Hg or lower at 25° C.

With such a liquid medium, clogging of the droplet discharge head with the secondary battery electrode ink can be prevented effectively and the productivity with which secondary battery electrodes are fabricated can be improved.

In the secondary battery electrode ink as described above, the liquid medium preferably includes at least one compound selected from the group consisting of dimethyl imidazolidinone, dimethyl formamide, dimethyl acetoamide, N-ethyl pyrrolidinone, N-propyl pyrrolidinone, N-butyl pyrrolidinone, N-pentyl pyrrolidinone, dimethyl-N, N′-dimethyl propyl urea, γ-butyrolactone, γ-nonalactone, propylene carbonate, methyl benzoate, ethyl benzoate, propyl benzoate, butyl benzoate, diethylene glycol diethyl ether, diethylene glycol ethyl methyl ether, and tripropylene glycol monomethyl ether.

With such a liquid medium, the damage to the epoxy adhesive is even less. As a result, the discharge stability of the ink is prevented from declining due to damage to the epoxy adhesive and the service life of the entire droplet discharge head is prevented from being shortened.

A lithium-ion battery includes the secondary battery electrode fabricated using the secondary battery electrode ink as described above.

Since such a lithium-ion battery can be manufactured without causing a large degree of damage to the droplet discharge head, it can be manufactured with excellent productivity. Additionally, since the electrode layer can be fabricated thinner, the internal resistance can be made sufficiently low and the patterning of the electrode layer can be accomplished more easily such that the discharge and recharge characteristics can be controlled.

An electronic device includes the lithium-ion battery as described above.

Such an electronic device is superior because it is equipped with a lithium-ion battery having excellent characteristics.

A method of manufacturing a secondary includes providing a current collector layer, and discharging the secondary battery electrode ink recited in claim 1 from a droplet discharge head of the droplet discharge device, in which a nozzle plate is fixedly coupled to the droplet discharge head with the epoxy adhesive material, onto the current collector layer.

Since the liquid medium imposes little damage on the epoxy adhesive, the nozzle plate remains securely joined to the droplet discharge head. As a result, the discharge stability of the ink is prevented from declining due to damage to the epoxy adhesive and the service life of the entire droplet discharge head is prevented from being shortened.

### BRIEF DESCRIPTION OF THE DRAWINGS

Referring now to the attached drawings which form a part of this original disclosure:

FIG. 1 is a schematic perspective view showing main components of a lithium-ion battery in accordance with one embodiment of the present invention;

FIG. 2 includes a pair of diagrams (a) and (b), wherein the diagram (a) is a side cross sectional view of a positive electrode and the diagram (b) is a side cross sectional view of a negative electrode of the lithium-ion battery in accordance with the embodiment of the present invention;

FIG. 3 is a simplified perspective view of a droplet discharge device used in fabricating electrodes of the lithium-ion battery in accordance with the embodiment of the present invention;

FIG. 4 includes a pair of diagrams (a) and (b), wherein the diagram (a) is a cross sectional perspective view of a droplet discharge head and the diagram (b) is a side cross sectional view of the droplet discharge head in accordance with the embodiment of the present invention; and

FIG. 5 is a perspective view of a personal computer exemplifying an electronic device in accordance with the one embodiment of the present invention.

### DETAILED DESCRIPTION OF EXEMPLARY EMBODIMENTS

Embodiments of the present invention will now be explained in more detail. A secondary battery electrode ink in accordance with the present invention is an ink used in manufacturing a secondary battery electrode of a lithium-ion battery (lithium-ion secondary battery. In particular, the secondary battery electrode ink is used to fabricate a secondary battery electrode using an inkjet method, which is a representative example of a droplet discharge method. This secondary battery electrode ink is for forming an electrode layer that is provided on a current collector layer; there is an ink for forming a positive electrode (hereinafter called “positive electrode ink”) and an ink for forming a negative electrode (hereinafter called “negative electrode ink”).

The positive electrode ink has the following solid components: a positive electrode active substance (active substance) containing Li—Mn based metal oxide, Li—Ni based metal oxide, Li—Co based metal oxide, Li—Fe based metal oxide, or a mixture of a plurality of these oxides; a carbon based conductive agent, such as acetylene black, ketjenblack, or graphite; and a binder (dispersed resin), such as polyvinylidene fluoride (PVDF), fluoride rubber, or ethylene-propylene-diene terpolymer (EPDM); As necessary, polymer dielectric materials, salts of lithium, and polymerization initiators are selected and added to the solid components. These solid components are dissolved and/or dispersed in a liquid medium to form a slurry that serves as the positive electrode ink.

The negative electrode ink has the following solid components: graphite, a graphitizable carbon, a non-graphitizable carbon, a Li—Ti based metal oxide, a Li—Sn based metal oxide, a Li—Si based metal oxide, or a mixture of a plurality of these materials; a carbon based conductive agent, such as acetylene black, ketjenblack, or graphite; and a binder (dispersed resin), such as polyvinylidene fluoride (PVDF), carboxymethyl cellulose (CMC), or styrene-butadiene rubber (SBR latex). As necessary, polymer dielectric materials, salts of lithium, and polymerization initiators are selected and added to the solid components. Sometimes polyimide (PI) is also added as a portion of the binder. These solid components are dissolved and/or dispersed in a liquid medium to form a slurry that serves as the negative electrode ink.

The polyvinylidene fluoride (PVDF) mentioned as a binder above has a binding effect with respect to carbon materials and metal current collectors (copper foil) and, thus, is used as a binder in the working examples described later.

The liquid medium used in such inks is a medium that functions to dissolve and/or disperse the solid components. In other words, the liquid medium functions as a solvent and/or a dispersant. Normally, most of the liquid medium is removed by vaporization during the process of fabricating an electrode layer. In the present invention, the liquid medium used also satisfies a certain condition that will now be explained.

The liquid medium is contrived such that when a cured epoxy adhesive material is soaked in the liquid medium under a sealed condition at atmospheric pressure and a temperature of approximately 50° C. for ten days, a weight increase rate (epoxy swelling amount) of the cured epoxy adhesive material is 130% or less. Here, the weight increase rate is defined to be the quotient of the weight (w2) after soaking divided by the weight (w1) before soaking expressed as a percentage, as indicated in the equation below.

Weight increase rate=(w2/w1)×100(%) (Equation)

The weight increase rate of the cured epoxy adhesive material can be measured using a disk-shaped test piece having a diameter of 6 mm and a thickness of 2 mm.

By using a liquid medium that satisfies the condition described above, the damage imposed on an epoxy adhesive by the liquid medium of the secondary battery electrode ink is reduced and an excellent discharge stability can be achieved by a droplet discharge head that uses an epoxy adhesive. More specifically, the liquid medium will cause the epoxy adhesive to swell and, thus, the adhesive strength will decline due to damage caused by the swelling. However, the degradation of the characteristics of the droplet discharge head caused by the decline in the adhesive strength is within an allowable range such that there is very little effect on the discharge stability.

As a result, such conditions as the amount of liquid droplets discharged can be held stable even when liquid droplet discharging is conducted for a long period of time, e.g., several months, and secondary battery electrodes can be fabricated with a stable degree of quality for a long period of time. Additionally, the service life of the droplet discharge head can be prevented from being shortened due to degradation caused by a large degree of damage to the droplet discharge head and the service life of the droplet discharge head can be lengthened. Furthermore, the productivity with which secondary battery electrodes are manufactured can be improved by the longer service life of the droplet discharge head because the frequency of replacements, repairs, and maintenance of the droplet discharge head can be decreased.

When the correlation between the durability of the droplet discharge head and the aforementioned weight increase rate of the cured epoxy adhesive was investigated, it was found that the droplet discharge head exhibits the required durability, e.g., can be used continuously for approximately 1.5 months, when the weight increase rate is 130% or smaller. Thus, as explained previously, the discharge stability can be maintained for a long period of time and the service life of the droplet discharge head can be lengthened. Meanwhile, if a liquid medium that causes the weight increase amount of the epoxy adhesive to exceed 130% is used, then, during the fabrication of secondary battery electrodes using an inkjet method, the manner in which liquid droplets are discharged will become unstable and it will become difficult to prevent the thickness of the electrode layer from varying.

In order to satisfy the requirement that the weight increase rate of the epoxy adhesive be 130% or smaller, any of the following substances, can be used as the liquid medium: dimethyl imidazolidinone, dimethyl formamide, dimethyl acetoamide, N-ethyl pyrrolidinone, N-propyl pyrrolidinone, N-butyl pyrrolidinone, N-pentyl pyrrolidinone, dimethyl-N, N′-dimethyl propyl urea, γ-butyrolactone, γ-nonalactone, propylene carbonate, methyl benzoate, ethyl benzoate, propyl benzoate, butyl benzoate, diethylene glycol diethyl ether, diethylene glycol ethyl methyl ether, and tripropylene glycol monomethyl ether, as well as the substances (solutions A to Q) used in the working examples as explained in detail below. In other words, an ink in accordance with the present invention preferably contains one or more of the substances.

It is also preferable for the boiling point of the liquid medium under atmospheric pressure (1 atmosphere) to be 180 to 300° C., more preferable for the same boiling point to be 190 to 280° C., and still more preferable for the same boiling point to be 200 to 265° C. When the boiling point of the liquid medium under atmospheric pressure is a value within these ranges, clogging of the droplet discharge head with the secondary battery electrode ink can be prevented effectively and the productivity with which secondary battery electrodes are fabricated can be improved.

It is also preferable for the vapor pressure of the liquid medium at a temperature of 25° C. to be 0.1 mm Hg or smaller and still more preferable for the same to be 0.05 mm Hg or smaller. When the vapor pressure of the liquid medium is a value within these ranges, clogging of the droplet discharge head with the secondary battery electrode ink can be prevented effectively and the productivity with which secondary battery electrodes are fabricated can be improved.

The content of the liquid medium in the secondary battery electrode ink is preferably 70 to 98 percent by weight and still more preferably 80 to 95 percent by weight. When the content of the liquid medium is a value within these ranges, the ink density is, for example, from approximately 6 to 10 mPas. As a result, the droplet discharge performance of the droplet discharge head is excellent and a sufficient amount of solid components can be contained in the ink.

The epoxy adhesive used for measuring the weight increase rate is preferably an epoxy adhesive that contains an epoxy resin and an aliphatic polyamine. With such an epoxy adhesive, a nozzle plate of the droplet discharge head (described later) can be securely fixed to the head body. Additionally, the droplet discharge head can be effectively prevented from undergoing undesirable vibrations during liquid droplet discharging. When NMP or acetonitrile is used as the liquid medium (solvent), the cured epoxy adhesive is easily damaged by the ink and it is difficult for a droplet discharge head that uses this kind of epoxy adhesive to maintain a sufficient discharge stability for a long period of time.

Conversely, when a liquid medium in accordance with the present invention is used, the cured epoxy adhesive is not easily damaged and the discharge stability of the ink can be maintained for a longer period of time. Additionally, the service life of the droplet discharge head can be extended.

An example of a lithium-ion battery that is manufactured using a secondary battery electrode ink like that described above will now be explained.

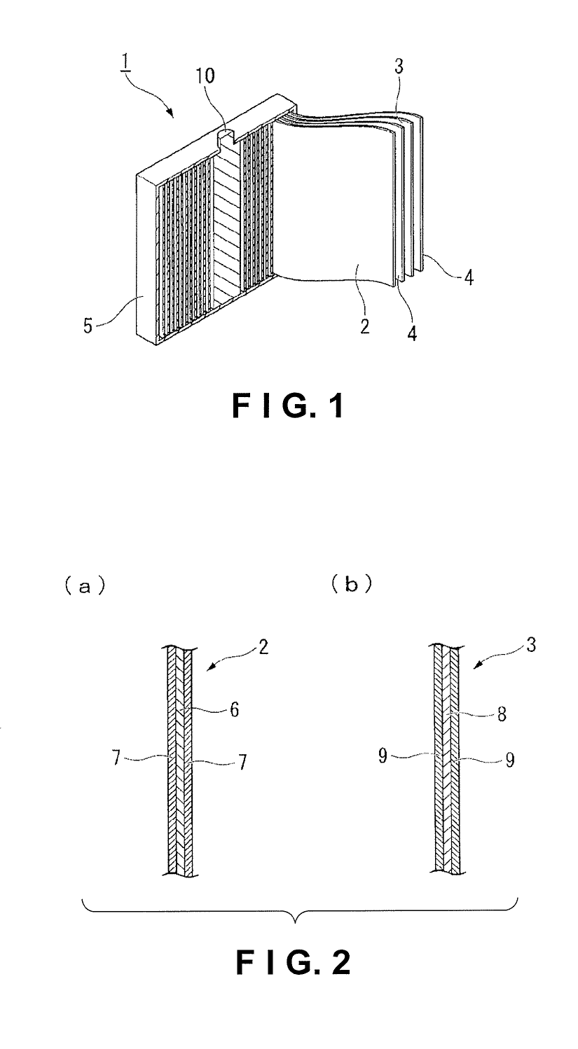

FIG. 1 is a diagrammatic view showing main components of a lithium-ion battery in accordance with the present invention. In FIG. 1, the reference numeral 1 indicates the lithium-ion battery. The lithium-ion battery 1 comprises multiple three-layered structures that are immersed in an electrolytic solution and sealed in a metal canlike case. Each of the three-layered structures comprises a sheet-like positive electrode material 2 (positive electrode), a sheet-like negative electrode material 3 (negative electrode), and a porous separator 4 provided between the positive electrode material and the negative electrode material.

As shown in FIG. 2 (a), each of the positive electrodes 2 comprises a rectangular sheet-like current collector layer (current collector) 6 having an electrode layer 7 formed on each of the front and back sides thereof. As shown in FIG. 2 (b), each of the negative electrodes 3 comprises a rectangular sheet-like current collector layer (current collector) 8 having an electrode layer 9 formed on each of the front and back sides thereof. The electrode layers 7 of the positive electrodes 2 are made of a positive electrode ink and contain a positive electrode active substance. Similarly, electrode layers 9 of the negative electrodes 3 are made of a negative electrode ink and contain a negative electrode active substance

The separator 4 is made of a porous polymer film. The current collector layer 6 of each of the positive electrodes 2 is made of an aluminum foil, and the current collector layer 8 of each of the negative electrodes 3 is made of a copper foil. The metal can-like case 5 is made of steel or aluminum. As shown in FIG. 1, a terminal 10 is provided on the lithium-ion battery 1. The terminal 10 is a positive terminal if the metal can-like case 5 is made of steel and a negative terminal if the metal can-like case 5 is made of aluminum. Furthermore, the metal can-like case 5 itself serves as a negative terminal when the terminal 10 is a positive terminal, and the metal can-like case 5 itself serves as a positive terminal when the terminal 10 is a negative terminal. An organic solvent in which a lithium salt has been dissolved is used as the electrolytic solution.

A manufacturing method for a lithium-ion battery configured as described above, particularly a method of forming the positive electrodes 2 and negative electrodes 3, will now be explained.

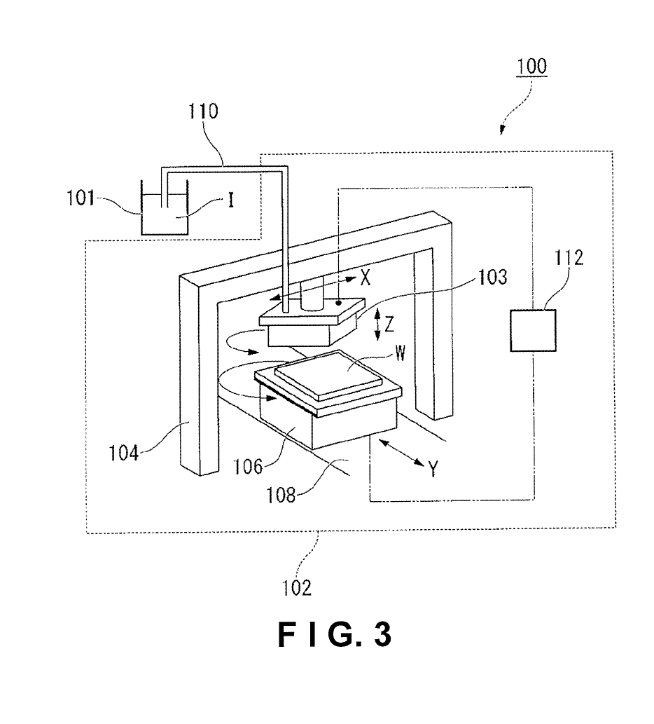

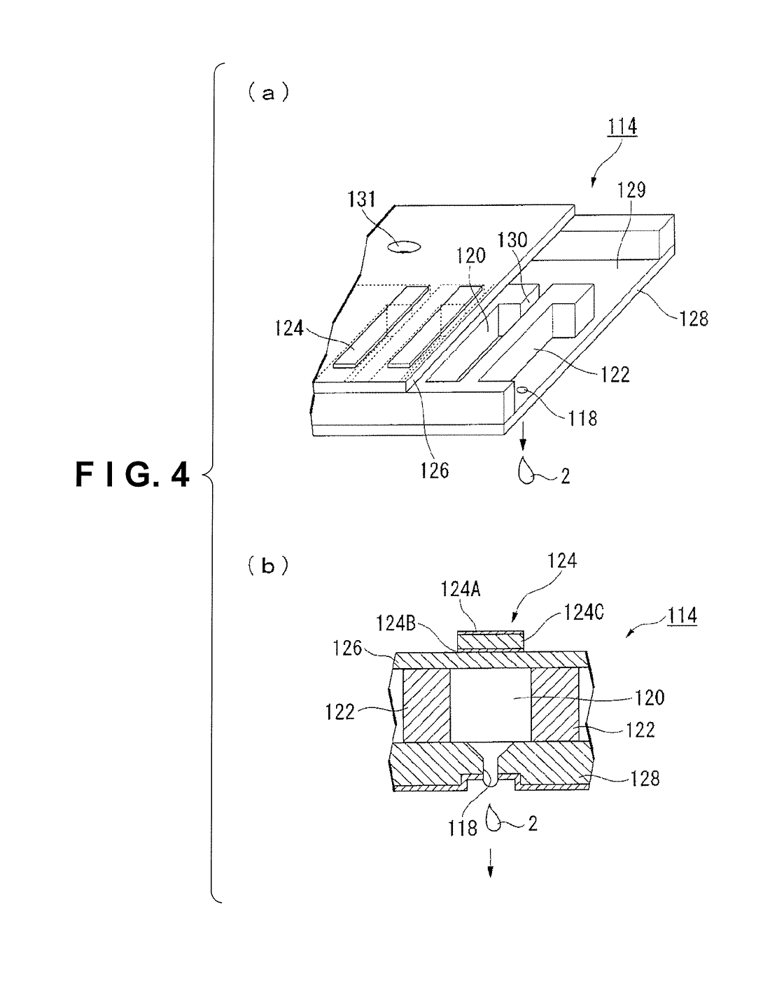

In the present invention, the electrodes, i.e., the positive electrodes 2 and the negative electrodes 3, are formed with a droplet discharge method (droplet discharge format) using a positive electrode ink and a negative electrode ink. The droplet discharge method (inkjet method) will first be explained with reference to FIGS. 3 and 4. FIG. 3 is a perspective view showing a droplet discharge apparatus and FIG. 4 shows a droplet discharge head of the droplet discharge apparatus shown in FIG. 3. FIG. 4 (a) is a cross sectional perspective view and FIG. 4 (b) is a cross sectional view.

As shown in FIG. 3, the droplet discharge apparatus 100 comprises a tank 101 configured to hold a secondary battery electrode ink I (positive electrode ink or negative electrode ink), a tube 110, and a discharge scan unit 102 to which the secondary battery electrode ink I is fed from the tank 101 via the tube 110. The discharge scan unit 102 is provided with droplet discharge device 103 having a plurality droplet discharge heads (inkjet heads, not shown) mounted on a carriage (not shown), a first position control device 104 (movement means) for controlling the position of the droplet discharge device 103, a stage 106 for holding a substrate W, a second position control device 108 (movement means) for controlling the position of the stage 106, and a controller 112. The substrate W is a current collection layer 6 or a current collection layer 8.

The tank 101 and the droplet discharge heads of the droplet discharge device 103 are connected by the tube 110, and the secondary battery electrode ink I is fed from the tank 101 to each of the droplet discharge heads.

The first position control device 104 is configured to move the droplet discharge device 103 along an X-axis direction and a Z-axis direction that is orthogonal to the X-axis direction in accordance with a signal from the controller 112. The first position control device 104 also functions to rotate the droplet discharge device 103 about an axis parallel to the Z-axis. In this embodiment, the Z-axis is oriented in a vertical direction. The second position control device 108 is contrived move the stage 106 along a Y-axis direction that is orthogonal to the X-axis direction and the Z-axis direction in accordance with a signal from the controller 112. The second position controller 108 also functions to rotate the stage 106 about an axis parallel to the Z-axis.

The stage 106 has a flat surface that is parallel to both the X-axis and the Y-axis. The stage 106 is contrived such that a substrate W onto which secondary battery electrode ink I will be discharged can be fixed to or held on the flat surface of the state 106.

The droplet discharge device 103 is moved along the X-axis direction by the first position control device 104 as explained previously. Similarly, the stage 106 is moved along the Y-axis direction by the second position control device 108. Thus, the relative positions of the droplet discharge heads with respect to the stage 6 are changed (i.e., the substrate W held on the stage 106 and the droplet discharge device 103 are moved relative to each other) by the first position control device 104 and the second position control device 108.

The controller 112 receives discharge data indicating a relative position where the secondary battery electrode ink I should be discharged from an external information processor and, based on the discharge data, controls the droplet discharge device 103, the first position control device 104, and the second position control device 108.

The droplet discharge device 103 has a plurality of droplet discharge heads (inkjet heads) 114 like that shown in FIGS. 4 (a) and (b) and a cartridge configured to hold the droplet discharge heads 114.

Each of the droplet discharge heads 114 comprises a vibration plate 126 and a nozzle plate 128. A fluid reservoir 129 is formed between the vibration plate 126 and the nozzle plate 128 as shown in FIG. 4(a). The secondary battery electrode ink I is fed from the tank 101 into the fluid reservoir 129 via a hole 131 such that the fluid reservoir 129 is constantly filled.

A plurality of partition walls 122 are also provided between the vibration plate 126 and the nozzle plate 128, and cavities 120 are formed by the spaces enclosed by the vibration plate 126, the nozzle plate 128, and pairs of partition walls 122. In this embodiment, the partition walls 122, the cavities 120, and the vibration plate 126 constitute the aforementioned head body.

One nozzle 118 is formed in the nozzle plate 128 with respect to each of the cavities 120 such that the number of cavities 120 and the number of nozzles 118 are the same. Secondary battery electrode ink I is supplied from the fluid reservoir 129 to the cavities 120 through supply openings 130 positioned between pairs of portioning walls 122.

An oscillator 124 is arranged on the vibration plate 126 with respect to each of the cavities 120. Each oscillator 124 is a piezoelectric element comprising a piezoelectric film 124C and a pair of electrodes 124A and 124B arranged to sandwich the piezoelectric film 124A. When a drive voltage is applied across the pair of electrodes 124A and 124B, secondary battery electrode ink I is discharged from the nozzle 118 of the corresponding cavity 120. The direction and shape of the nozzles 118 is contrived so that the secondary battery electrode ink I is discharged in the Z-axis direction from the nozzles 118.

With this kind of droplet discharge head 114, an adhesive is typically used in places where parts of the droplet discharge head 114 are joined together. For example, an adhesive is used at the joints between the nozzle plate 128 and the partition walls 122 (which greatly affect the durability of the droplet discharge head) and at the joints between the vibration plate 126 and the partition walls 122. When droplets of the secondary battery electrode ink I are repeatedly discharged, the secondary battery electrode ink I continues to be fed into the droplet discharge head 114 (cavity 120) and vibrational energy associated with discharging droplets acts on the joint portions where the adhesive is used.

An industrial droplet discharge apparatus used to manufacture secondary battery electrodes is completely different from a droplet discharge apparatus used in a typical home or office printer. For example, in order to conduct mass production, an industrial droplet discharge apparatus is required to discharge large quantities of droplets over a long period of time. Additionally, the ink that is used with an industrial droplet discharge apparatus generally has a higher viscosity and a larger specific gravity than the ink used in a typical printer. Thus, the load imposed on an industrial droplet discharge head is much larger than that imposed on a typical printer.

Due to the excessive conditions under which industrial droplet discharge apparatuses are used, conventional secondary battery electrode inks cause the adhesive to swell and the adhesive strength of the adhesive to become insufficient, as explained in Patent Documents 1 and 3. As a result, such problems as the droplet discharge amount becoming unstable and the apparatus becoming unable to discharge droplets at all have occurred. The apparatuses used in manufacturing are generally subjected to a cleaning operation involving a suction process once per prescribed period of time. If the adhesive strengths of the nozzle plate 128 and/or the vibration plate 126 have declined, then the pressure change that occurs during the suction process will cause such structural defects as warping or sagging because the droplet discharge head will not be able withstand the pressure change. As a result, the discharge of droplets from some of the nozzles will become unstable and there will be variation of the discharge characteristics among the nozzles.

When this kind of problem occurs, it is not possible to form an electrode layer with the desired thickness in a uniform manner, i.e., the film thickness of the electrode layer is uneven, and the characteristics of the electrodes obtained become unstable. Additionally, variation occurs among the electrodes formed and, thus, performance variations occur among the lithium-ion batteries obtained. Conversely, with the present invention, since the secondary battery electrode ink satisfies the aforementioned conditions, the kinds of problems described above can be prevented in an effective manner even if droplet discharging is conducted for a long period of time.

While there are no particular limitations on the droplet discharge head 114, the droplet discharge head is preferably one in which the nozzle plate 128 is attached to the partition walls 122, i.e., the head body, with an epoxy adhesive having an excellent chemical resistance. Since a secondary battery electrode ink in accordance with the present invention causes little damage to the epoxy adhesive of such a droplet discharge head 114, the droplet discharge head 114 can maintain an excellent discharge stability and the service life of the droplet discharge head 114 can be prevented from being shortened due to severe damage to the droplet discharge head 114.

It is also preferable for the epoxy adhesive used in the droplet discharge head 114 to contain an epoxy resin and an aliphatic polyamine. A droplet discharge head that uses this kind of epoxy adhesive will be resistant to the solvents typically contained in inks and the joints between the metal, silicon, or other parts making up the head will remain strong. As a result, the droplet discharge head can be effectively prevented from undergoing undesirable vibrations when liquid droplets are discharged from the droplet discharge head. Conversely, when a conventional secondary battery electrode ink employing NMP or acetonitrile (each of which has a very high polarity) is used as the liquid medium, the cured epoxy adhesive is readily vulnerable to the ink and can easily become swollen or otherwise severely damaged. Consequently, when a conventional secondary battery electrode ink is used in a droplet discharge head having joints made of an epoxy adhesive as described above, the droplet discharge head cannot maintain its mechanical strength for a long period of time and, thus, it is difficult to maintain the discharge stability of the droplet discharge head.

Conversely, when a liquid medium in accordance with the present invention is used, the cured epoxy adhesive is not easily damaged and the discharge stability of the ink can be maintained for a longer period of time. Additionally, the service life of the droplet discharge head can be extended. Additionally, since the components of the epoxy adhesive do not readily dissolve out of the epoxy adhesive, impurities can be effectively prevented from becoming mixed into the product.

Examples of epoxy adhesives used in the droplet discharge head 114 include AE-40 (AE-40, manufactured by Ajinomoto Fine-Techno Co., Ltd.), 931-1 (manufactured by Ablestik), Loctite 3609 (manufactured by Henkel Japan, Ltd.), and Scotch-Weld EW2010 (manufactured by 3M).

In order to form the positive electrodes 2 and negative electrodes 3 of a lithium-ion battery 1 using a droplet discharge apparatus 100 configured as described above, first the current collector layers 6 and 8 are prepared. As explained previously, the current collector layers 6 forming the positive electrodes 2 and are made of an aluminum foil, and the current collector layers 8 forming the negative electrodes 3 are made of a copper foil.

A prepared current collector layer 6 (or 8) is placed on the stage 106 as a substrate W as shown in FIG. 3. Then, the controller 112 controls the droplet discharge device 103, the first position control device 104, and the second position control device 108. In this way, the current collector layer 6 (8) is moved relative to the droplet discharge head 114 of the droplet discharge device 103 while secondary battery electrode ink I is discharged from the droplet discharge head 114 onto the current collector layer 6 (8).

The droplet discharging executed by the droplet discharge device 103 and the position of the current collector layer 6 (8), i.e., the positioning (movements) executed by the first position control device 104 and the second position control device 108, are controlled by the controller 112 such that the secondary battery electrode ink I is applied to the current collector layer 6 (8) to the desired thickness in a uniform manner (i.e., such that the thickness is uniform). Since the secondary battery electrode ink I is applied such that the film formed is sufficiently thin, the liquid medium contained in the ink I evaporates almost completely and is removed from the film. If necessary, it is acceptable to conduct a drying treatment to forcefully remove residual liquid medium from the film.

After a thin film is formed on one side of the current collector layer 6 (8), the thin film is cured by heating if necessary. Then, a thin film is formed on the other side of the current collector layer 6 (8) using the same processing steps. Thus, a thin film of the secondary battery electrode ink I is formed on the other side of the current collector layer 6 (8), too. The thin films are then heated to thoroughly remove any residual liquid medium and cure the films. If necessary, the cured thin films are compressed to adjust them to a specified thickness. In this way, electrode layers 7 (or 9) containing a positive active substance or a negative active substance are formed on both surfaces of a current collector layer 6 (8) as shown in FIGS. 2 (a) and (b), thereby forming a positive electrode 2 or a negative electrode 3.

Afterwards, positive electrodes 2 and negative electrodes 3 fabricated as described above are assembled in a conventional manner to obtain a lithium-ion battery 1 like that shown in FIG. 1.

Since such a lithium-ion battery 1 can be manufactured without causing a large degree of damage to the droplet discharge head 114, it can be manufactured with excellent productivity. Additionally, since the electrode layers 7 (9) can be fabricated thinner, the internal resistance of the positive electrodes 2 and the negative electrodes 3 can be made sufficiently low and the patterning of the electrode layer 7 (9) can be accomplished more easily such that the discharge and recharge characteristics can be controlled.

An electronic device that employs a lithium-ion battery like that described above will now be explained.

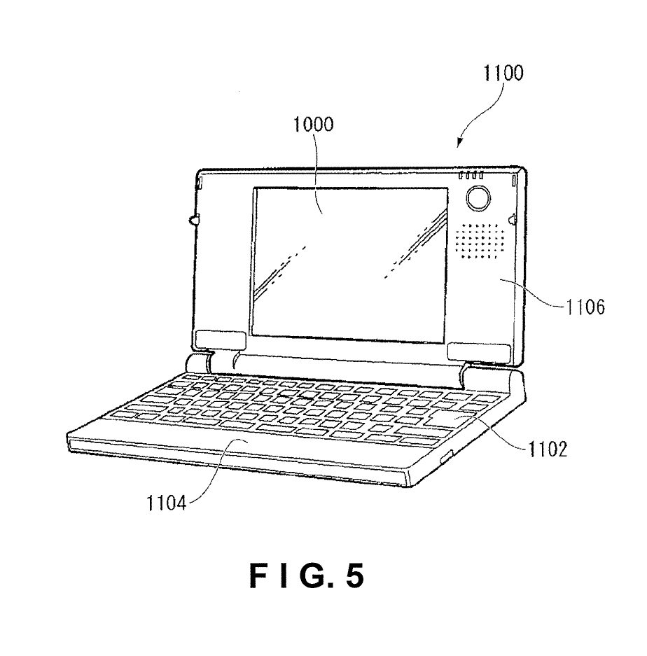

FIG. 5 is a perspective view illustrating an example in which the electronic device in accordance with the present invention is a mobile (or notebook) personal computer.

As shown in FIG. 5, the personal computer 1100 comprises a main unit 1104 provided with a keyboard 1102 and a display unit 1106. The display unit 1106 is rotatably supported on the main unit 1104 via a hinge structure.

The personal computer 1100 is equipped with a lithium-ion battery like that shown in FIG. 1 as a power source.

Thus, the personal computer 1100 itself is superior because it is equipped with a lithium-ion battery having the excellent characteristics described previously.

In addition to personal computers (mobile personal computers), other examples of electronic devices to which the present invention can be applied include mobile telephones, digital still cameras, televisions (e.g., LCD televisions), video cameras, view finder type and monitor viewing type video tape recorders, and laptop personal computers.

Additionally, other than in electronic devices, a lithium-ion battery in accordance with the present invention can also be used in an automobile or any other device that requires a power source.

### WORKING EXAMPLES

Secondary battery electrode inks I for making positive electrodes were prepared as will now be explained.

Lithium manganese oxide (LiMn₂O₄) was used as a positive electrode active substance, carbon black was used as a conductive agent, and polyvinylidene fluoride (PVDF) was used as a dispersed resin (binder) and binding agent. These solid components were mixed in appropriate ratios. A liquid medium (mixture of solutions) was prepared by mixing a plurality of solvents or solutions and added to the solid components so as to dissolve/disperse the solid components, thereby obtaining a slurry (dispersion liquid), i.e., a positive electrode ink (secondary battery electrode ink I). Different combinations of solid components and liquid media were used to obtain Working Examples 1 to 23 and Comparative Examples 1 to 12.

The mixing ratios (content amounts) of the solid components and the types (reference letters), boiling points, and mixing ratios (content amounts) of the solvents used in each of the Working Examples 1 to 23 are shown in Table 1. The mixing ratios (content amounts) of the solid components and the types (reference letters), boiling points, and mixing ratios (content amounts) of the solvents used in each of the Comparative Examples 1 to 12 are shown in Table 2.

Additionally, both Table 1 and Table 2 show the viscosity of the positive electrode ink and the epoxy swelling amount or weight (the weight increase rate as defined using the equation described above in the present embodiment) of the liquid medium (mixture of solutions) for each example. The mixing ratios (content amounts) are indicated in the units of percent by weight (wt %).

TABLE 1

| | SECONDARY BATTERY ELECTRODE INK (POSITIVE ELECTRODE INK) | | | | | | |
|---|---|---|---|---|---|---|---|
| | COMPOSITION | | | | | | |
| | ELECTRODE | | | | | | |
| | ACTIVE | CONDUCTIVE | DISPERSED | BINDING | SOLUTION 1 | | |
| | SUBSTANCE | AGENT | RESIN | AGENT | BOILING | | |
| | CONTENT | CONTENT | CONTENT | CONTENT | POINT | | CONTENT |
| | (wt %) | (wt %) | (wt %) | (wt %) | (° C.) | | (wt %) |
| WORKING EXAMPLE 1 | 8.8 | 1.2 | 3.5 | 2.9 | A | 260 | 33.4 |
| WORKING EXAMPLE 2 | 8.8 | 1.2 | 3.6 | 2.8 | A | 260 | 33.4 |
| WORKING EXAMPLE 3 | 8.8 | 1.2 | 3.3 | 3 | A | 260 | 33.5 |
| WORKING EXAMPLE 4 | 8.8 | 1.2 | 3.1 | 3.3 | A | 260 | 33.4 |
| WORKING EXAMPLE 5 | 8.8 | 1.2 | 3.4 | 3.1 | A | 260 | 33.4 |
| WORKING EXAMPLE 6 | 8.8 | 1.2 | 3.5 | 2.8 | A | 260 | 33.5 |
| WORKING EXAMPLE 7 | 8.8 | 1.2 | 3.5 | 3 | A | 260 | 33.4 |
| WORKING EXAMPLE 8 | 8.8 | 1.2 | 3.2 | 3.1 | A | 260 | 41.9 |
| WORKING EXAMPLE 9 | 8.8 | 1.2 | 3.3 | 3.2 | A | 260 | 33.4 |
| WORKING EXAMPLE 10 | 8.8 | 1.2 | 3.5 | 2.9 | A | 260 | 50.2 |
| WORKING EXAMPLE 11 | 8.5 | 1.5 | 3.2 | 3.2 | B | 245 | 33.4 |
| WORKING EXAMPLE 12 | 8.5 | 1.5 | 3.3 | 3.1 | B | 245 | 33.4 |
| WORKING EXAMPLE 13 | 8.5 | 1.5 | 3.5 | 2.7 | B | 245 | 33.5 |
| WORKING EXAMPLE 14 | 8.5 | 1.5 | 3.1 | 3.3 | B | 245 | 33.4 |
| WORKING EXAMPLE 15 | 8.1 | 1.9 | 2.9 | 3.3 | C | 218 | 25.1 |
| WORKING EXAMPLE 16 | 8.1 | 1.9 | 3.7 | 2.8 | C | 218 | 25.1 |
| WORKING EXAMPLE 17 | 8.6 | 1.4 | 3.3 | 3.1 | D | 245 | 33.4 |
| WORKING EXAMPLE 18 | 8.6 | 1.4 | 3.4 | 3 | D | 245 | 25.1 |
| WORKING EXAMPLE 19 | 8.6 | 1.4 | 3.2 | 3.3 | D | 245 | 33.4 |
| WORKING EXAMPLE 20 | 8.3 | 1.7 | 3.5 | 3.1 | E | 225 | 37.5 |
| WORKING EXAMPLE 21 | 8.3 | 1.7 | 3.6 | 2.9 | F | 245 | 41.8 |
| WORKING EXAMPLE 22 | 8.3 | 1.7 | 3.3 | 3.4 | F | 245 | 41.7 |
| WORKING EXAMPLE 23 | 8.3 | 1.7 | 3.1 | 3.5 | Q | 202 | 29.2 |

| | SECONDARY BATTERY ELECTRODE INK | | | | | | | |
|---|---|---|---|---|---|---|---|---|
| | (POSITIVE ELECTRODE INK) | | | | | | | |
| | COMPOSITION | | | | | | CHARACTERISTICS | |
| | SOLUTION 2 | | | SOLUTION 3 | | | EPOXY | |
| | BOILING | | | BOILING | | | SWELLING | INK |
| | POINT | | CONTENT | POINT | | CONTENT | WEIGHT | VISCOSITY |
| | (° C.) | | (wt %) | (° C.) | | (wt %) | (%) | (mPas) |
| WORKING EXAMPLE 1 | H | 242 | 25.1 | L | 242 | 25.1 | 80 | 9.0 |
| WORKING EXAMPLE 2 | H | 242 | 25.1 | J | 176 | 25.1 | 108 | 8.0 |
| WORKING EXAMPLE 3 | H | 242 | 25.1 | M | 215 | 25.1 | 106 | 8.1 |
| WORKING EXAMPLE 4 | H | 242 | 25.1 | N | 192 | 25.1 | 104 | 8.1 |
| WORKING EXAMPLE 5 | H | 242 | 25.1 | K | 222 | 25.1 | 115 | 8.1 |
| WORKING EXAMPLE 6 | H | 242 | 25.1 | O | 213 | 25.1 | 101 | 8.2 |
| WORKING EXAMPLE 7 | H | 242 | 25.1 | P | 170 | 25.1 | 110 | 8.2 |
| WORKING EXAMPLE 8 | H | 242 | 41.9 | — | — | 0.0 | 94 | 8.4 |
| WORKING EXAMPLE 9 | G | 204 | 50.1 | — | — | 0.0 | 112 | 7.9 |
| WORKING EXAMPLE 10 | — | — | 0.0 | L | 242 | 33.4 | 105 | 9.3 |
| WORKING EXAMPLE 11 | H | 242 | 25.1 | J | 176 | 25.1 | 101 | 7.9 |
| WORKING EXAMPLE 12 | H | 242 | 25.1 | M | 215 | 25.1 | 99 | 8.0 |
| WORKING EXAMPLE 13 | H | 242 | 25.1 | O | 213 | 25.1 | 93 | 8.0 |
| WORKING EXAMPLE 14 | G | 204 | 25.1 | J | 176 | 25.1 | 120 | 7.7 |
| WORKING EXAMPLE 15 | G | 204 | 25.1 | P | 170 | 33.5 | 118 | 7.4 |
| WORKING EXAMPLE 16 | G | 204 | 33.4 | I | 188 | 25.1 | 117 | 7.5 |
| WORKING EXAMPLE 17 | H | 242 | 25.1 | I | 188 | 25.1 | 107 | 8.1 |
| WORKING EXAMPLE 18 | G | 204 | 33.4 | I | 188 | 25.1 | 116 | 7.8 |
| WORKING EXAMPLE 19 | H | 242 | 25.1 | N | 192 | 25.1 | 108 | 8.2 |
| WORKING EXAMPLE 20 | G | 204 | 33.4 | P | 170 | 12.5 | 116 | 7.6 |
| WORKING EXAMPLE 21 | G | 204 | 25.1 | P | 170 | 16.7 | 116 | 7.9 |
| WORKING EXAMPLE 22 | H | 242 | 29.2 | M | 215 | 12.5 | 94 | 8.1 |
| WORKING EXAMPLE 23 | H | 242 | 33.4 | M | 215 | 20.9 | 109 | 8.0 |

TABLE 2

| | SECONDARY BATTERY ELECTRODE INK (POSITIVE ELECTRODE INK) | | | | | | |
|---|---|---|---|---|---|---|---|
| | COMPOSITION | | | | | | |
| | ELECTRODE | | | | | | |
| | ACTIVE | CONDUCTIVE | DISPERSED | BINDING | SOLUTION 1 | | |
| | SUBSTANCE | AGENT | RESIN | AGENT | BOILING | | |
| | CONTENT | CONTENT | CONTENT | CONTENT | POINT | | CONTENT |
| | (wt %) | (wt %) | (wt %) | (wt %) | (° C.) | | (wt %) |
| COMPARATIVE EXAMPLE 1 | 8.3 | 1.7 | 3.1 | 3.2 | Q | 202 | 83.7 |
| COMPARATIVE EXAMPLE 2 | 8.3 | 1.7 | 3.4 | 3.2 | Q | 202 | 58.4 |
| COMPARATIVE EXAMPLE 3 | 8.3 | 1.7 | 3.2 | 3.4 | Q | 202 | 58.4 |
| COMPARATIVE EXAMPLE 4 | 8.8 | 1.2 | 3.5 | 2.9 | A | 260 | 66.9 |
| COMPARATIVE EXAMPLE 5 | 8.8 | 1.2 | 3.3 | 3.1 | A | 260 | 66.9 |
| COMPARATIVE EXAMPLE 6 | 8.3 | 1.7 | 3.4 | 3.2 | E | 225 | 70.9 |
| COMPARATIVE EXAMPLE 7 | 8.3 | 1.7 | 3.3 | 3.3 | E | 225 | 62.6 |
| COMPARATIVE EXAMPLE 8 | 8.3 | 1.7 | 3.5 | 2.8 | E | 225 | 54.4 |
| COMPARATIVE EXAMPLE 9 | 8.1 | 1.9 | 2.9 | 3.3 | C | 218 | 58.7 |
| COMPARATIVE EXAMPLE 10 | 8.1 | 1.9 | 3.4 | 3.3 | C | 218 | 58.3 |
| COMPARATIVE EXAMPLE 11 | 8.6 | 1.4 | 3.1 | 3.5 | D | 245 | 62.6 |
| COMPARATIVE EXAMPLE 12 | 8.6 | 1.4 | 3.3 | 3.2 | D | 245 | 54.3 |

| | SECONDARY BATTERY ELECTRODE INK | | | | | | | |
|---|---|---|---|---|---|---|---|---|
| | POSITIVE ELECTRODE INK) | | | | | | | |
| | COMPOSITION | | | | | | | |
| | SOLUTION 2 | | | SOLUTION 3 | | | CHARACTERISTICS | |
| | BOILING | | | BOILING | | | EPOXY | INK |
| | POINT | | CONTENT | POINT | | CONTENT | SWELLING | VISCOSITY |
| | (° C.) | | (wt %) | (° C.) | | (wt %) | WEIGHT (%) | (mPas) |
| COMPARATIVE EXAMPLE 1 | — | — | 0.0 | — | — | 0.0 | 178 | 7.5 |
| COMPARATIVE EXAMPLE 2 | — | — | 0.0 | J | 176 | 25.0 | 164 | 7.3 |
| COMPARATIVE EXAMPLE 3 | G | 204 | 25.0 | — | — | 0.0 | 150 | 7.5 |
| COMPARATIVE EXAMPLE 4 | H | 242 | 16.7 | — | — | 0.0 | 131 | 8.5 |
| COMPARATIVE EXAMPLE 5 | G | 204 | 16.7 | — | — | 0.0 | 142 | 8.4 |
| COMPARATIVE EXAMPLE 6 | G | 204 | 12.5 | — | — | 0.0 | 136 | 7.7 |
| COMPARATIVE EXAMPLE 7 | G | 204 | 12.5 | K | 222 | 8.3 | 153 | 7.7 |
| COMPARATIVE EXAMPLE 8 | G | 204 | 16.7 | P | 170 | 12.6 | 142 | 7.6 |
| COMPARATIVE EXAMPLE 9 | G | 204 | 25.1 | — | — | 0.0 | 141 | 7.8 |
| COMPARATIVE EXAMPLE 10 | G | 204 | 25.0 | — | — | 0.0 | 141 | 7.8 |
| COMPARATIVE EXAMPLE 11 | G | 204 | 12.5 | K | 222 | 8.3 | 170 | 8.4 |
| COMPARATIVE EXAMPLE 12 | G | 204 | 16.7 | P | 170 | 12.5 | 156 | 8.2 |

The solvents that correspond to each of the reference letters shown in Tables 1 and 2 are indicated below. In addition to the name of the solvent, the epoxy swelling amount or weight (the weight increase rate as defined using the equation described above in the present embodiment) and the viscosity are also indicated as follows.

| | | | Epoxy | |
|---|---|---|---|---|
| Reference | | Boiling | Swelling | |
| Letter | | Point | Weight | Viscosity |
| (Code) | Solvent Name | (° C.) | (wt %) | (mPas) |
| A: NNP | N-pentyl pyrrolidone | 260 | 156.13 | 2.8 |
| B: NBP | N-butyl pyrrolidone | 245 | 142.28 | 2.5 |
| C: NEP | N-ethyl pyrrolidone | 218 | 165.35 | 2.09 |
| D: DMPU | NN-dimethyl propyl urea | 245 | 164.33 | 2.91 |
| E: DMI | dimethyl imidazolidinone | 225 | 145.46 | 1.94 |
| F: NMF | N-methyl formanilide | 245 | 114.13 | 2.5 |
| G: gBL | γ-butyrolactone | 204 | 83.01 | 1.7 |
| H: PC | propylene carbonate | 242 | 32.04 | 2.4 |
| I: EDE | diethylene glycol diethyl | 188 | 27.81 | 1.4 |
| | ether | | | |
| J: EDM | diethylene glycol methyl | 176 | 40.82 | 1.2 |
| | ethyl ether | | | |
| K: PHMM | ethylene glycol phenyl | 222 | 60.06 | 2 |
| | methyl ether | | | |
| L: MFTG | tripropylene glycol methyl | 242 | 27.31 | 4.5 |
| | ether | | | |
| M: BDM | diethylene glycol butyl | 215 | 35.92 | 1.6 |
| | methyl ether | | | |
| N: BMGA | diethylene glycol ethyl | 192 | 30.92 | 1.6 |
| | ether acetate | | | |
| O: DPMA | dipropylene glycol methyl | 213 | 21.7 | 1.7 |
| | ether acetate | | | |
| P: EEP | ethoxypropionic acid ethyl | 170 | 45.12 | 1.2 |
| Q: NMP | N-methyl pyrrolidone | 202 | 180.01 | 1.65 |

The viscosities of the secondary battery electrode inks listed for the working examples and comparative examples in Tables 1 and 2 and the solvent viscosities listed above were measured at 25° C. using a vibrational viscometer in compliance with the standard JISZ8809. The boiling points indicate the boiling temperature of each of the solvents at normal pressure (1 atmosphere), and the swelling weights of the epoxy adhesive (which contains AE-40 manufactured by Ajinomoto Fine-Techno, an epoxy resin, and an aliphatic polyamine) were measured by soaking a cured piece (disk-shaped test piece 6 mm in diameter and 4 mm thick) of the epoxy adhesive in the liquid medium under sealed conditions at atmospheric pressure and a temperature of 50° C. for ten days and then measuring the swelling weight (weight increase amount).

Each of the secondary battery electrode inks of the working examples 1 to 23 were discharged from the droplet discharge head 114 described above so as to form electrode layers 7 as shown in FIG. 2. The electrode layers 7 were successfully formed to the desired thickness with a uniform thickness. Droplet discharging was continued for a long period of time without incurring a large degree of damage to the droplet discharge head 114 and it was confirmed that the service life of the droplet discharge head 114 can be lengthened.

Meanwhile, each of the secondary battery electrode inks of the comparative examples 1 to 12 were discharged from the droplet discharge head 114 described above so as to form electrode layers 7 as shown in FIG. 2. These electrode layers 7 exhibited unevenness of thickness. Additionally, when droplet discharging was continued for a long period of time with the inks of the comparative examples, the droplet discharge head 114 incurred a large degree of damage and, in some cases, the nozzle plate peeled away from the head body.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A secondary battery electrode ink adapted to be discharged from a droplet discharge device to make an electrode layer of a secondary battery, the secondary battery electrode ink comprising:
an active substance including at least one of
a positive electrode active substance including one of or a mixture of a plurality of Li—Mn based metal oxide, Li—Ni based metal oxide, Li—Co based metal oxide and Li—Fe based metal oxide, and
a negative electrode active substance including one of or a mixture of a plurality of graphite, graphitizable carbon, non-graphitizable carbon, Li—Ti based metal oxide, Li—Sn based metal oxide and Li—Si based metal oxide; and
a liquid medium that dissolves and/or disperses the active substance, the liquid medium having a characteristic in which, when a cured epoxy adhesive material is put into the liquid medium under a sealed condition at an atmospheric pressure and a temperature of approximately 50° C. and left for ten days, a weight increase rate of the cured epoxy adhesive material is 130% or less.

2. The secondary battery electrode ink recited in claim 1, wherein
the active substance includes the positive electrode active substance.

3. The secondary battery electrode ink recited in claim 1, wherein
the active substance includes the negative electrode active substance.

4. The secondary battery electrode ink recited in claim 1, wherein
the epoxy adhesive material contains an epoxy resin and an aliphatic polyamine.

5. The secondary battery electrode ink recited in claim 1, wherein
the liquid medium has a boiling point of from 180° C. to 300° C. under an atmospheric pressure.

6. The secondary battery electrode ink recited in claim 1, wherein
the liquid medium has a vapor pressure of 0.1 mm Hg or lower at 25° C.

7. The secondary battery electrode ink recited in claim 1, wherein
the liquid medium includes at least one compound selected from the group consisting of dimethyl imidazolidinone, dimethyl formamide, dimethyl acetoamide, N-ethyl pyrrolidinone, N-propyl pyrrolidinone, N-butyl pyrrolidinone, N-pentyl pyrrolidinone, dimethyl-N, N′-dimethyl propyl urea, γ-butyrolactone, γ-nonalactone, propylene carbonate, methyl benzoate, ethyl benzoate, propyl benzoate, butyl benzoate, diethylene glycol diethyl ether, diethylene glycol ethyl methyl ether, and tripropylene glycol monomethyl ether.

8. A lithium-ion battery having a secondary battery electrode fabricated using the secondary battery electrode ink recited in claim 1.

9. An electronic device having the lithium-ion battery recited in claim 8.

10. A method of manufacturing a secondary battery comprising:
providing a current collector layer; and
discharging the secondary battery electrode ink recited in claim 1 from a droplet discharge head of the droplet discharge device, in which a nozzle plate is fixedly coupled to the droplet discharge head with the epoxy adhesive material, onto the current collector layer.
